(19) United States
(12) Patent Application Publication
(10) Pub. No.: US 2011/0249769 A1
(43) Pub. Date: Oct. 13, 2011

(54) METHOD AND APPARATUS OF COMPENSATION FOR AMPLITUDE AND PHASE DELAY USING SUB-BAND POLYPHASE FILTER BANK IN BROADBAND WIRELESS COMMUNICATION SYSTEM

(75) Inventors: Min Soo Kang, Daejeon (KR); Chong-Hoon Kim, Seoul (KR); Woo Jin Byun, Daejeon (KR); Kwang Seon Kim, Daejeon (KR); Bong-Su Kim, Daejeon (KR); Myung Sun Song, Daejeon (KR)

(73) Assignees: Soongsil University Research Consortium Techno-park, Seoul (KR); ELECTRONICS AND TELECOMMUNICATIONS RESEARCH INSTITUTE, Daejeon (KR)

(21) Appl. No.: 12/974,634

(22) Filed: Dec. 21, 2010

(30) Foreign Application Priority Data
Apr. 8, 2010 (KR) 10-2010-0032196

(51) Int. Cl. H04L 25/49; H04L 27/00

(52) U.S. Cl. 375/296; 375/316

(57) ABSTRACT

Provided is a method and apparatus improving a deterioration of a gain flatness and a phase characteristic that may be incurred while a baseband signal is transformed into a immediate frequency (IF) signal and a radio frequency (RF) signal in a broadband wireless communication system. A sub-band extractor may divide the broadband signal into multiple sub-band signals, may pre-compensate for a gain and a phase delay of each sub-band signals in the baseband, and may combine the pre-compensated sub-band signals into the single broadband signal and thus, the deterioration of the gain flatness and a phase delay flatness that may be incurred while the broadband signal is transformed into the IF signal and the RF to signal, may be improved.

### CROSS-REFERENCE TO RELATED APPLICATION

This application claims the benefit of Korean Patent Application No. 10-2010-0032196, filed on Apr. 8, 2010, in the Korean Intellectual Property Office, the disclosure of which is incorporated herein by reference.

### BACKGROUND

1. Field of the Invention

The present invention relates to a method of compensating for an amplitude and a phase delay in a broadband wireless communication system.

2. Description of the Related Art

Current communication systems being developed transmit a greater amount of information than before and thus, a broader frequency resource may be used. Also, the current communication systems tend to use a modulation scheme having a higher frequency efficiency, such as QPSK, 8 PSK, 16 QAM, and the like, rather than existing modulation schemes, such as an On-Off Keying (OOK) scheme which is simple. As a frequency band becomes broader, it becomes more difficult to maintain a flatness and to prevent a phase deterioration in a communication system using a high modulation scheme.

### SUMMARY

An aspect of the present invention provides an apparatus and method compensating for a gain flatness characteristic and a phase deterioration in a band while a base band signal is transformed into an intermediate frequency (IF) signal and a radio frequency (RF) signal in a broadband wireless communication system.

According to an aspect of the present invention, there is provided an apparatus of compensating for an amplitude deterioration and a phase deterioration, the apparatus including a sub-band extracting end to divide, using a polyphase filter bank, an input signal into N sub-band signals, a pre-compensating end to pre-compensate for the amplitude deterioration or the phase delay of each of the N sub-band signals by comparing each of the N sub-band signals with a reference signal having information associated with an amplitude to deterioration or a phase delay with respect to each of N sub-bands, and a sub-band combining end to transform the N pre-compensated sub-band signals into a single broadband signal by combining the N pre-compensated sub-band signals, each of the N pre-compensated sub-band signals having a pre-compensated amplitude or a pre-compensated phase.

The sub-band extracting end may include an 1:N demultiplexer to transform the input signal into the N sub-band signals to enable a bandwidth of each of the N sub-band signals to be 1/N of a bandwidth of the input signal, an extracting end polyphase filter bank unit to use a finite impulse response (FIR) filter structure, and to perform low pass filtering with respect to each of the N sub-band signals, and a fast Fourier transform (FFT) execution unit to generate the N sub-band signals by applying an FFT scheme to outputs of the extracting end polyphase filter bank unit.

The extracting end polyphase filter bank unit may include N polyphase filters, each of the N polyphase filter performing low pass filtering with respect to one of N outputs of the 1:N demultiplexer.

The extracting end polyphase filter bank unit may include k*N polyphase filters to perform low pass filtering, groups of k polyphase filters being respectively connected with one of N outputs of the 1:N demultiplexer, and N k:1 multiplexers, each of the N k:1 multiplexers selecting one of output signals of the k*N polyphase filters having the same sub-band, to outputting the selected signal.

The FFT execution unit may generate the N sub-band signals based on a Radix-N FFT scheme.

The pre-compensating end may include N pre-compensators, each of the N pre-compensators being connected with one of outputs of the sub-band extracting end, and the pre-compensator may include an amplitude comparer to compare an amplitude of the input signal with an amplitude of the reference signal to generate an amplitude control signal, and an amplitude adjustor to change the amplitude of the input signal based on the amplitude control signal.

The pre-compensating end may include N pre-compensators, each of the N pre-compensators being connected with one of outputs of the sub-band extracting end, and the pre-compensator may include a phase comparer to compare a phase of the input signal with a phase of the reference signal to generate a phase control signal and a phase adjustor to change the phase of the input signal based on the phase control signal.

The sub-band combining end may include an inverse fast Fourier transform (IFFT) execution unit to apply an IFFT scheme to the N pre-compensated sub-band signals, each of the N pre-compensated sub-band signals having the pre-compensated amplitude or the pre-compensated phase, a combining end polyphase filter bank unit being connected to outputs of the IFFT execution unit to generate sub-band signals used for generating the single broadband signal, and an N:1 multiplexer to sequentially combine outputs of the combining polyphase filter bank unit.

The combining polyphase filter bank unit may include N polyphase filters, each of the N polyphase filters being connected with one of the outputs of the IFFT execution unit to generate the sub-band signals used for generating the single broadband signal.

The combining polyphase filter bank may include N 1:k demultiplexers, each of the N 1:k demultiplexers dividing one of the outputs of the IFFT unit into k signals, and k*N polyphase filters, groups of k polyphase filters being respectively connected with one of outputs of the N 1:k demultiplexers to generate the sub-band signals used for generating the single broadband signal.

The IFFT execution unit may apply the Radix-N FFT scheme to the N pre-compensated sub-band signals.

According to an aspect of the present invention, there is provided a method of compensating for an amplitude deterioration and a phase deterioration, the method including dividing an input signal into N sub-band signals, pre-compensating for an amplitude or a to phase delay of each of the N sub-band signals by comparing each of the N sub-band signals with a reference signal having information associated with an amplitude deterioration or a phase delay with respect to each of sub-bands, and transforming the N pre-compensated sub-band signals into a single broadband signal by combining the N pre-compensated sub-band signals, each of the N pre-compensated sub-band signals having a pre-compensated amplitude or a pre-compensated phase.

The dividing may include transforming the input signal into the N sub-band signals to enable a bandwidth of each of the N sub-band signals to be 1/N of a bandwidth of the input signal, performing low pass filtering with respect to each of the N sub-band signals, and using an FIR filter structure, and applying an FFT scheme to the N sub-band signals that are low pass filtered.

The performing of the low pass filtering may include performing low pass filtering using polyphase filters, each of the polyphase filters being connected to one of N outputs of the 1:N demultiplexer.

The performing of the low pass filtering may include performing low pass filtering using k*N polyphase filters, groups of k polyphase filters being respectively connected with one of N outputs of the 1:N demultiplexer, and selecting, by each of N k:1 multiplexers, one of output signals of the k*N polyphase filters having the same sub-band to output the selected signal.

The pre-compensating may include generating an amplitude control signal by comparing an amplitude of each of the N sub-band signals with an amplitude of the reference signal, and changing the amplitude of each of the N sub-band signals based on the amplitude control signal.

The pre-compensating may include generating a phase control signal by comparing a phase of each of the N sub-band signals with a phase of the reference signal, and changing the phase of each of the N sub-band signals based on the phase control signal.

The transforming may include applying an IFFT scheme to the N pre-compensated sub-band signals, each of the N pre-compensated sub-band signals having a pre-compensated amplitude or a pre-compensated phase, generating, using the IFFT-processed signals, the sub-band signals used for generating the single broadband signal, and sequentially combining, using an N:1 multiplexer, the sub-band signals used for generating the single broadband signal.

The generating may include transforming, using N polyphase filters, the IFFT-processed signals into the sub-band signals used for generating the single broadband signal.

The generating may include dividing, by N 1:k demultiplexer, each of the IFFT-processed signals into k signals, and generating the sub-band signals used for generating the single broadband signal, using k*N polyphase filters, groups of k polyphase filters being respectively connected with one of the N 1:k demultiplexers.

Additional aspects, features, and/or advantages of the invention will be set forth in part in the description which follows and, in part, will be apparent from the description, or may be learned by practice of the invention.

According to embodiments, when a broadband wireless transmitter, such as a communication system of a several Gbps in a millimeter wave band, processes a broadband signal, a gain flatness in a band may be improved and a phase delay flatness deterioration in a band may be improved by dividing the broadband signal into sub-band signals through a polyphase filter bank, pre-compensating an amplitude and a phase in a base band, and combining the pre-compensated sub-band signals.

According to embodiments, a broadband signal is divided into N sub-band signals through a polyphase filter bank to transform a high-speed broadband data into a low-speed sub-band data, the low-speed being 1/N of the high-speed, and thus, a high-speed broadband data processing may be performed. A number of taps of an FIR filter of each sub-band signal may be 1/N of a number of taps of a prototype filter, and sub-band signals may be to processed in parallel and thus, hardware may be easily embodied.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating an equalizer used in a receiving end according to an embodiment of the present invention;

FIG. 2 is a block diagram illustrating a sub-band-based amplitude and phase compensating apparatus using a polyphase filter bank according to an embodiment of the present invention;

FIG. 3 is a block diagram illustrating an example of a sub-band extracting end of FIG. 2;

FIG. 4 is a block diagram illustrating an example of a pre-compensator of FIG. 2.

FIG. 5 is a block diagram illustrating an example of a sub-band combining end of FIG. 2; and

FIG. 6 is a flowchart illustrating a method of compensating for an amplitude deterioration and a phase delay according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

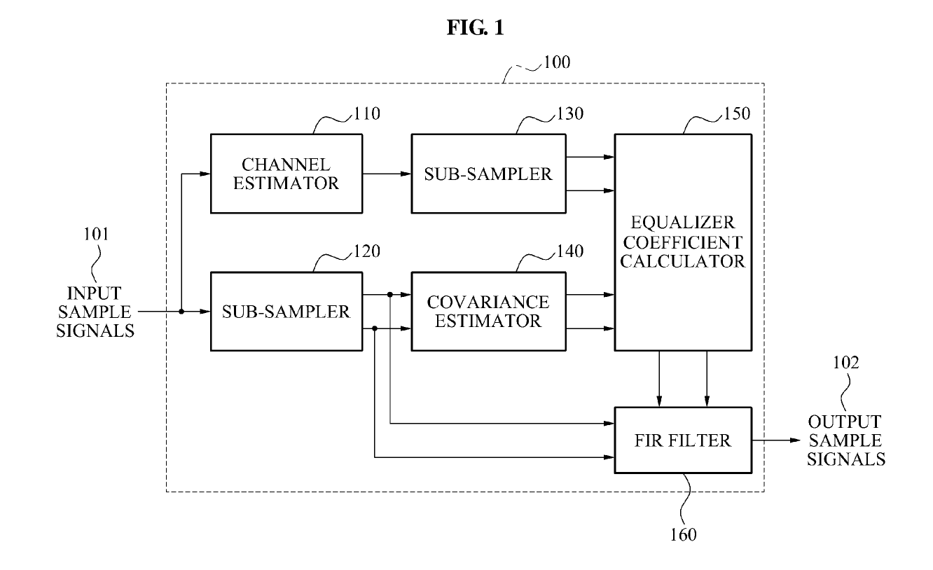

FIG. 1 is a block diagram illustrating an equalizer used in a receiving end according to an embodiment of the present invention

Referring to FIG. 1, the equalizer is generally used in a block for digital-processing in the receiving end. The equalizer 100 may include a channel estimating unit 110, a sub-sampler 120, a sub-sampler 130, a covariance estimator 140, an equalizer coefficient calculator 150, and a Finite Impulse Response (FIR) filter 160.

An operation of the equalizer will be described below. A signal received via an antenna passes through a radio frequency (RF) and intermediate frequency (IF) circuit and is transformed into a base band signal, and the transformed signal passes through an analog digital converter (ADC) and is transformed into a digital sample signal. Digital sample signals, such as an input sample signals 101, may be provided to the equalizer 100 to improve a gain flatness in a bandwidth of a receiver.

The input sample signals 101 provided to the equalizer 100 may be provided to the channel estimator 110 and the sub-sampler 120. The signals provided to the sub-sampler 120 may be sub-sampled and provided to the covariance estimator 140, and may be provided to the FIR filter 160. Output signals of the covariance estimator 140 may be provided to the equalizer coefficient calculator 150 to calculate an equalizer coefficient. The signals provided to the channel estimator 110 may pass through the sub-sampler 130, and may be provided to the equalizer coefficient calculator 150 to calculate the equalizer coefficient. The equalizer coefficient calculator 150 may determine the equalizer coefficient by comparing signals provided from the sub-sampler 130 with signals provided from the covariance estimator 140. The calculated the equalizer coefficient may be provided to the FIR filter 160 to adjust a coefficient of the FIR filter and thus, output sample signals 102, each of the sample signals having a compensated gain and a compensated phase.

As an amount of information to be transmitted by the equalizer 100 increases, a desired range of a frequency of a baseband is broader. A high-speed ADC may be used for generating the digital sample signal, and a device, such as a field programmable gate array (FPGA) and the like, may be used to process the digital sample signal at a high-speed. However, a current device technology, such as the ADC, the FPGA, and the like, may not process a high-speed operation using a single path in a communication system of a several Gbps capacity, such as a millimeter wave band.

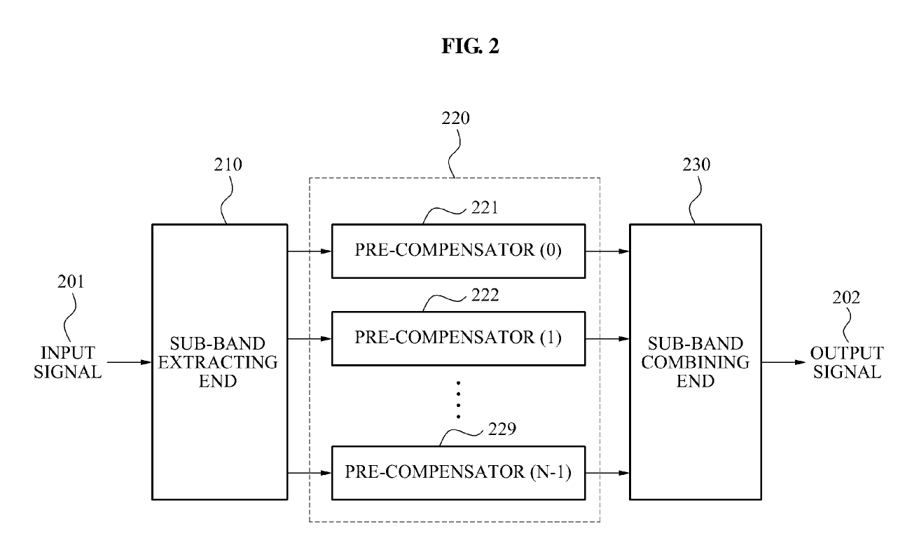

FIG. 2 illustrates a sub-band based amplitude and phase compensating apparatus using a polyphase filter bank according to an embodiment of the present invention.

Referring to FIG. 2, the sub-band based amplitude and phase compensating apparatus using the polyphase filter bank may include a sub-band extracting end 210, a pre-compensating end 220, and a sub-band combining end 230. The sub-band based amplitude and phase compensating apparatus may be used in a transmitting end.

The sub-band extractor 210 may receive an input signal 210 having a broadband characteristic and may divide the input signal 201 into N sub-band signals.

The pre-compensating end 220 may include N pre-compensators, such as a pre-compensator (0) 221, a pre-compensator (1) 222, . . . , and a pre-compensator (N−1) 229. The pre-compensator (0) 221, the pre-compensator (1) 222, . . . , and the pre-compensator (N−1) 229 may adjust an amplitude or a phase of each of outputs of the sub-band extracting end 210 to have a pre-compensated characteristic, such as a pre-compensated gain or a pre-compensated phase, to compensate deterioration of a gain flatness and a phase flatness in a band, the deterioration being incurred when the input signal 210 passes through an IF block and an RF block.

The sub-band combining end 230 may generate an output signal 202 having a broadband characteristic by combining N output signals of the pre-compensating end 220, each of the N output signals having a pre-compensated amplitude or a pre-compensated phase. Pre-compensation for deterioration characteristics, such as a deterioration of a gain flatness and a phase delay, to be incurred when the output signal 202 is passing through the IF block and the RF block may be performed and thus, a gain flatness and a phase delay flatness of a final transmission signal in a band may be improved.

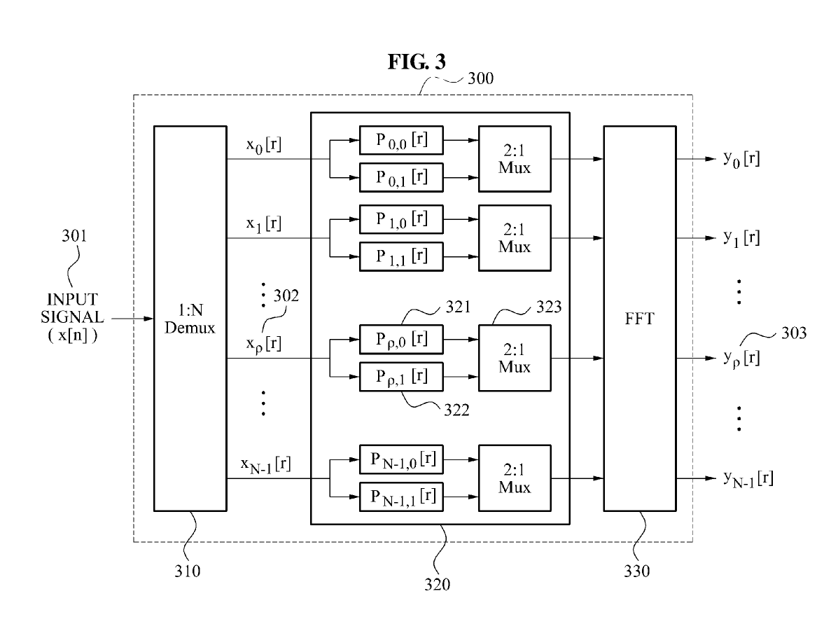

FIG. 3 illustrates an example of a sub-band extracting end of FIG. 2.

Referring to FIG. 3, a sub-band extracting end 300 may include an 1:N demultiplexer 310, an extracting end polyphase filter bank unit 320, and a fast Fourier transform (FFT) execution unit 330.

The 1:N demultiplexer 310 may transform, or may perform time-division of, an input signal 310 into N sub-band signals, to enable a bandwidth of each of the N sub-band signals to be 1/N of a bandwidth of the input signal 301.

The extracting end polyphase filter bank unit 320 may use a FIR filter structure, and may perform low pass filtering with respect to each of the N sub-band signals.

The FFT execution unit 330 may apply an FFT scheme to outputs of the polyphase filter bank unit 320 to generate the N sub-band signals.

N band pass wave filters having a band of 2π/N and a center frequency of 2πk/N (k=0, 1, . . . , N−1) may be used to extract the N sub-band signals which have even narrower bandwidths from a complex digital input signal having a broadband frequency characteristic, and N mixers may be used to transform the N sub-band signals into baseband signals. A broadband signal is divided into sub-band signals through the band pass wave filter and each of the sub-band signals may be transformed into a baseband signal through the mixer. In this example, a bandwidth of the transformed signal is 2π/N. Accordingly, when the transformed signal is down-sampled based on an integer number M being less than N and greater than or equal to 1, information may be maintained without damage.

A k^{th} sub-band may be embodied through a low pass wave filter. When the low pass wave filter is used, unlike the band pass wave filter, the same low pass wave filter may be applied to all sub-bands and thus, the sub-band extracting end may be easily embodied. This may be expressed by Equation 1. When the input complex signal is x[n], an output of the low pass wave filter of the k^{th} sub-band, namely, xₖ[n], may be expressed by Equation 1.

$$\begin{matrix}{x}_{k} [ n ] = P [ n ] * ( x [ n ] {W}_{N}^{- kn} ) \\ = {\sum }_{{n}^{′}} P [ n - {n}^{′} ] x [ {n}^{′} ] {W}_{N}^{{kn}^{′}} .\end{matrix} \qquad [ Equation 1 ]$$

In this example, P[n] denotes a pulse response of the low pass wave filter and W_{N}^{kn}=e^{j2πkn/N}. To reduce an amount of data, 1/M down sampling may be performed with respect to each of the N sub-band signals, and output of the down sampling, namely, yₖ[m], may be expressed by Equation 2.

$$\begin{matrix}{y}_{k} [ m ] = {x}_{k} [ mM ] \\ = {\sum }_{{n}^{′}} P [ mM - {n}^{′} ] x [ {n}^{′} ] {W}_{N}^{- {kn}^{′}} .\end{matrix} \qquad [ Equation 2 ]$$

When n′=rN+ρ and ρ□{0, 1, 2, . . . , N−1} in Equation 2, W_{N}^{-km=1} and thus, Equation 3 may be expressed as below.

$${y}_{k} [ m ] = {\sum }_{ρ = 0}^{N - 1} {W}_{N}^{- k ρ} {\sum }_{r} P [ mM - rN - ρ ] x [ rN + ρ ] . \qquad [ Equation 3 ]$$

When a relationship between N being a number of sub-bands and M being a number of down-sampling is N=IM, I being an integer number, Equation 4 may be expressed as below.

$${y}_{k} [ m ] = {\sum }_{ρ = 0}^{N - 1} {W}_{N}^{- k ρ} {\sum }_{r} P [ ( m - rI ) M - ρ ] x [ rN + ρ ] . \qquad [ Equation 4 ]$$

When an input of a ρ^{th} polyphase is x_{ρ}[r]=x[rN+ρ], and a polyphase filter is P_{ρ}[r]=P[rM−ρ], Equation 4 may be expressed by Equation 5.

$${y}_{k} [ m ] = {\sum }_{ρ = 0}^{N - 1} {W}_{N}^{- k ρ} {\sum }_{r} {P}_{ρ} [ m - rI ] {x}_{ρ} [ r ] . \qquad [ Equation 5 ]$$

When N=M, it may be a most efficient structure to embody N polyphase filters. However, in this example, an image may be generated in an adjacent band while signals are combined after being passing through the filters and thus, N=2M may be a most efficient structure, practically. Accordingly, when each of the sub-bands is configured to be divided into two channels to embody a structure of a filter of N=2M(I=2), a sub-band extractor of FIG. 3 may be embodied. In this example, P_{ρ,0}[m] and P_{ρ,1}[m] may have a relationship where P_{ρ,0}[m]=P_{ρ}[2m] and P_{ρ,1}[m]=P_{ρ}[2m+1].

Referring to FIG. 3, the 1:N demultiplexer 310 may transform the input signal 301, namely, x[n], having a broadband signal character into N narrowband signals, each of the N narrowband signals having a 1/N bandwidth of a bandwidth of the input signal 301.

The extracting end polyphase filter bank unit 320 may include k*N polyphase filters, such as polyphase filters 321 and 322, to perform low pass filtering, groups of k polyphase filters being respectively connected to one of N outputs of the 1:N demultiplexer 310, and may include N k:1 multiplexer, such as a 2:1 multiplexer 323, each of the N k:1 multiplexer 323 selecting one of output signals of the k*N polyphase filters having the same sub-band, and outputting the selected signal.

A signal processing of the extracting end polyphase filter bank unit 320 will be described in detail as below. When k=2, namely, N=2M, x_{ρ}[r] 302 that is an input of a p^{th} polyphase, is provided to two polyphase filters 321 and 322. Each of the polyphase filters 321 and 322 may have an FIR structure and performs low pass filtering. The 2:1 multiplexer 323 may select one of output signals of the two polyphase filters 321 and 322 to output the selected signal. Even when k is greater than or equal to 2, the k:1 multiplexer may be operated in the same manner. When k=1, a single polyphase filter having an FIR structure, as opposed to having two polyphase filters 321 and 322 and the 2:1 multiplexer, and performing low pass filter may be connected with x_{ρ}[r] 302 that is the input of the p^{th} to polyphase.

The FFT execution unit 330 may perform an FFT scheme with respect to N output signals received from the extracting end polyphase filter bank 320 to generate signals 303, such as y₀[r], . . . , y_{N-1}[r], for each frequency band. In this example, a Radix-N FFT scheme may be used as the FFT scheme.

When the input signal 301 of a broadband is divided into N sub-band signals and processed and thus, an FIR filter structure having a 1/N number of taps compared with an FIR filter structure used for processing a signal occupying an entire frequency such as the input signal 301 and thus, the sub-band extracting end may be easily embodied.

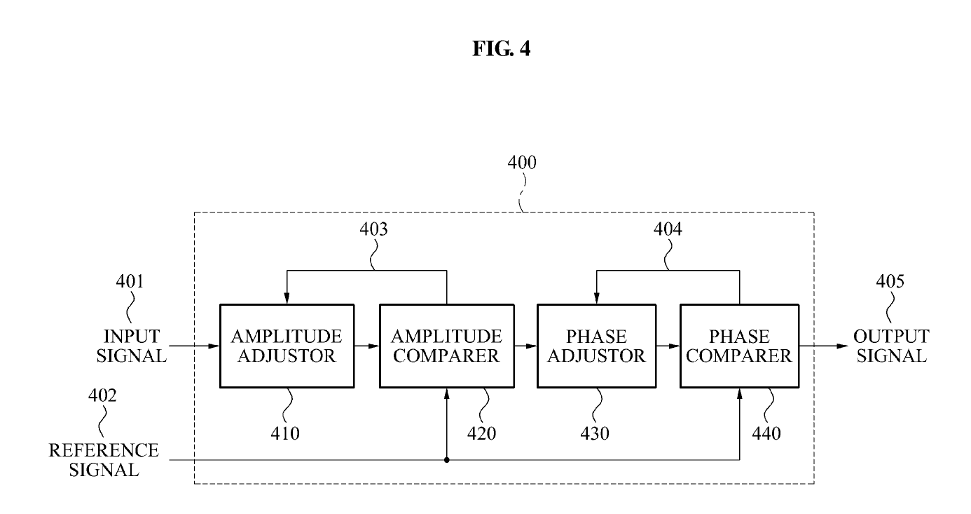

FIG. 4 is a block diagram illustrating an example of a pre-compensator of FIG. 2.

Referring to FIG. 4, the pre-compensator 400 may include an amplitude adjustor 410, an amplitude comparer 420, a phase adjuster 430, and a phase comparer 440.

The pre-compensator 400 may compare an amplitude and a phase of each of extracted sub-band signals with a reference signal of each sub-band.

The amplitude comparer 420 may compare amplitude information, or gain information, of an input signal 401 with a reference signal 402 including information associated with a gain flatness deterioration and a phase deterioration incurred while each of the sub-band signals passes through an IF block and RF block, to generate an amplitude control signal 403. The amplitude adjustor 410 may adjust an amplitude of the input signal 401 based on the amplitude control signal 403. Accordingly, pre-compensation for the gain flatness deterioration for each sub-band, the deterioration being incurred while each of the sub-band signals passes through the IF block and the RF block, may be performed.

The phase comparer 440 may compare phase delay information of the input signal 401, or an output signal of the amplitude comparer 420, with the reference signal 402, to generate a phase control signal 404. The phase adjustor 430 may adjust a phase of the input signal 401 based on the phase control signal 404. Accordingly, pre-compensation for phase to deterioration for each sub-band, the deterioration being incurred each of the sub-band signals passes through the IF block and the RF block, may be performed.

A sequence of arrangement of an amplitude changing apparatus and a phase adjusting apparatus, the amplitude changing apparatus including the amplitude adjustor 410 and the amplitude comparer 420 and the phase adjusting apparatus including the phase adjustor 430 and the phase comparer 440, may be changed.

An output signal 405 may be a signal having a controlled phase and a controlled amplitude of a sub-band, and the output signal 405 may be provided to the sub-band combining end 230 of FIG. 2.

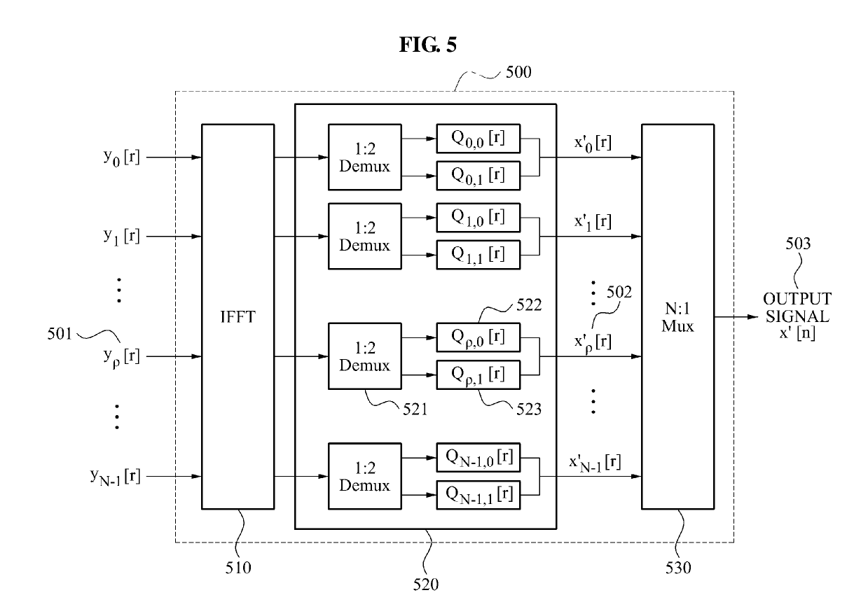

FIG. 5 illustrates an example of a sub-band combining end of FIG. 2.

Referring to FIG. 5, a sub-band combining end 500 may include an IFFT execution unit 510, a combining end polyphase filter bank unit 520, and an N:1 multiplexer 530. The sub-band combining end 500 may inversely perform the signal processing of the sub-band extracting end of FIG. 2 to combine, into a single broadband signal, N sub-band signals which are divided by the sub-band extracting end.

The IFFT execution unit 510 may apply an inverse fast Fourier transform (IFTT) to N signals 501 inputted from a pre-compensating end. In this example, Radix-N IFFT scheme may be used as the IFFT scheme.

The combining end polyphase filter bank unit 520 may include N 1:k demultiplexers, each of N 1:k demultiplexers dividing one of outputs of the IFFT execution unit 510 into k signals, and may include k*N polyphase filters to perform low pass filtering, group of k polyphase filters being respectively connected to one of the N 1:k demultiplexers.

The signal processing of the combining polyphase filter bank unit 520 will be further described below. In this example, the signal processing may be described based on a p^{th} polyphase input among inputs of the combining polyphase filter bank unit 520 when k=2, namely, N=2M. A 1:2 demultiplexer 521 may divide the p^{th} polyphase input into two signals. Two polyphase filters 522 and 523 may receive the two signals, respectively, and may generate a p^{th} sub-band signal 502 used for generating a single broadband signal. Even when k is greater than or equal to 2, operations may proceed in the same manner. When k=1, a single polyphase filter, as opposed to the 1:2 demultiplexer 521 and the two polyphase filters 522 and 523, may be connected to the p^{th} polyphase input.

The N:1 multiplexer 530 may sequentially combine N sub-band signals to generate an output signal 503, namely, x′[n], that is the single broadband signal.

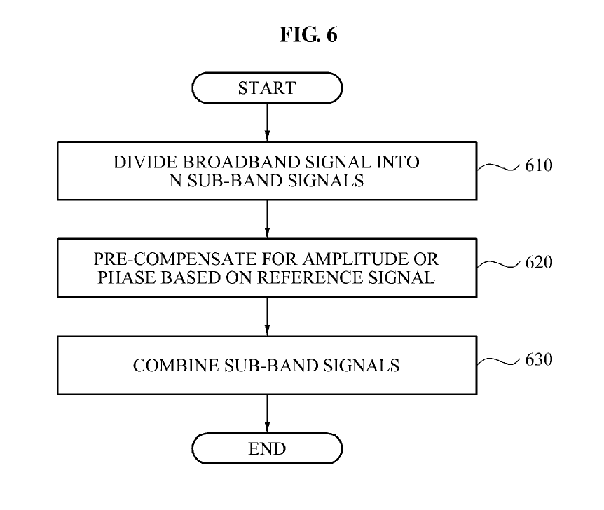

FIG. 6 illustrates a method of compensating for an amplitude deterioration and a phase delay according to an embodiment of the present invention.

Referring to FIG. 6, an input broadband signal is divided into N sub-band signals, through a polyphase filter bank in operation 610.

A pre-compensation for an amplitude or a phase delay of each of the N sub-band signals is performed by comparing each of the N sub-band signals with a reference signal including information associated with an amplitude deterioration or a phase delay for each sub-band, in operation 620.

The pre-compensated sub-band signals, each of the pre-compensated sub-band signal having a pre-compensated amplitude or a pre-compensated phase, are combined into a single broadband signal in operation 630.

When the pre-compensated signal is transmitted, an amplitude deterioration or a phase deterioration that may be incurred during an IF operation and RF operation may be prevented from being incurred.

The compensation method of compensating for the amplitude deterioration or the phase delay has been described. Example embodiments described with reference to FIGS. 2 through 5 may be applicable to the compensation method and thus, detailed description thereof will be omitted.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus of compensating for an amplitude deterioration and a phase deterioration, the apparatus comprising:
a sub-band extracting end to divide, using a polyphase filter bank, an input signal into N sub-band signals;
a pre-compensating end to pre-compensate for the amplitude deterioration or the phase delay of each of the N sub-band signals by comparing each of the N sub-band signals with a reference signal having information associated with an amplitude deterioration or a phase delay with respect to each of N sub-bands; and
a sub-band combining end to transform the N pre-compensated sub-band signals into a single broadband signal by combining the N pre-compensated sub-band signals, each of the N pre-compensated sub-band signals having a pre-compensated amplitude or a pre-compensated phase.

2. The apparatus of claim 1, wherein the sub-band extracting end comprises:
an 1:N demultiplexer to transform the input signal into the N sub-band signals to enable a bandwidth of each of the N sub-band signals to be 1/N of a bandwidth of the input signal;
an extracting end polyphase filter bank unit to use a finite impulse response (FIR) filter structure, and to perform low pass filtering with respect to each of the N sub-band signals; and
a fast Fourier transform (FFT) execution unit to generate the N sub-band signals by applying an FFT scheme to outputs of the extracting end polyphase filter bank unit.

3. The apparatus of claim 2, wherein the extracting end polyphase filter bank unit includes N polyphase filters, each of the N polyphase filter performing low pass filtering with respect to one of N outputs of the 1:N demultiplexer.

4. The apparatus of claim 2, wherein the extracting end polyphase filter bank unit comprises:
k*N polyphase filters to perform low pass filtering, groups of k polyphase filters being respectively connected with one of N outputs of the 1:N demultiplexer; and
N k:1 multiplexers, each of the N k:1 multiplexers selecting one of output signals of the k*N polyphase filters having the same sub-band, to outputting the selected signal.

5. The apparatus of claim 2, wherein the FFT execution unit generates the N sub-band signals based on a Radix-N FFT scheme.

6. The apparatus of claim 1, wherein:
the pre-compensating end includes N pre-compensators, each of the N pre-compensators being connected with one of outputs of the sub-band extracting end,
wherein the pre-compensator comprises:
an amplitude comparer to compare an amplitude of the input signal with an amplitude of the reference signal to generate an amplitude control signal; and
an amplitude adjustor to change the amplitude of the input signal based on the amplitude control signal.

7. The apparatus of claim 1, wherein:
the pre-compensating end comprises N pre-compensators, each of the N pre-compensators being connected with one of outputs of the sub-band extracting end,
wherein the pre-compensator comprises:
a phase comparer to compare a phase of the input signal with a phase of the reference signal to generate a phase control signal; and
a phase adjustor to change the phase of the input signal based on the phase control signal.

8. The apparatus of claim 1, wherein the sub-band combining end comprises:
an inverse fast Fourier transform (IFFT) execution unit to apply an IFFT scheme to the N pre-compensated sub-band signals, each of the N pre-compensated sub-band signals having the pre-compensated amplitude or the pre-compensated phase;
a combining end polyphase filter bank unit being connected to outputs of the IFFT execution unit to generate sub-band signals used for generating the single broadband signal; and
an N:1 multiplexer to sequentially combine outputs of the combining polyphase filter bank unit.

9. The apparatus of claim 8, wherein the combining polyphase filter bank unit comprises N polyphase filters, each of the N polyphase filters being connected with one of the outputs of the IFFT execution unit to generate the sub-band signals used for generating the single broadband signal.

10. The apparatus of claim 8, wherein the combining polyphase filter bank comprises:
N 1:k demultiplexers, each of the N 1:k demultiplexers dividing one of the outputs of the IFFT unit into k signals; and
k*N polyphase filters, groups of k polyphase filters being respectively connected with one of outputs of the N 1:k demultiplexers to generate the sub-band signals used for generating the single broadband signal.

11. The apparatus of claim 8, wherein the IFFT execution unit applies the Radix-N FFT scheme to the N pre-compensated sub-band signals.

12. A method of compensating for an amplitude deterioration and a phase deterioration, the method comprising:
dividing an input signal into N sub-band signals;
pre-compensating for an amplitude or a phase delay of each of the N sub-band signals by comparing each of the N sub-band signals with a reference signal having information associated with an amplitude deterioration or a phase delay with respect to each of sub-bands; and
transforming the N pre-compensated sub-band signals into a single broadband signal by combining the N pre-compensated sub-band signals, each of the N pre-compensated sub-band signals having a pre-compensated amplitude or a pre-compensated phase.

13. The method of claim 12, wherein the dividing comprises:
transforming the input signal into the N sub-band signals to enable a bandwidth of each of the N sub-band signals to be 1/N of a bandwidth of the input signal;
performing low pass filtering with respect to each of the N sub-band signals, and using an FIR filter structure; and
applying an FFT scheme to the N sub-band signals that are low pass filtered.

14. The method of claim 13, wherein the performing of the low pass filtering comprises performing low pass filtering using polyphase filters, each of the polyphase filters being connected to one of N outputs of the 1:N demultiplexer.

15. The method of claim 13, wherein the performing of the low pass filtering comprises:
performing low pass filtering using k*N polyphase filters, groups of k polyphase filters being respectively connected with one of N outputs of the 1:N demultiplexer; and
selecting, by each of? N k:1 multiplexers, one of output signals of the k*N polyphase filters having the same sub-band to output the selected signal.

16. The method of claim 12, wherein the pre-compensating comprises:
generating an amplitude control signal by comparing an amplitude of each of the N sub-band signals with an amplitude of the reference signal; and
changing the amplitude of each of the N sub-band signals based on the amplitude control signal.

17. The method of claim 12, wherein the pre-compensating comprises:
generating a phase control signal by comparing a phase of each of the N sub-band signals with a phase of the reference signal; and
changing the phase of each of the N sub-band signals based on the phase control signal.

18. The method of claim 12, wherein the transforming comprises:
applying an IFFT scheme to the N pre-compensated sub-band signals, each of the N pre-compensated sub-band signals having a pre-compensated amplitude or a pre-compensated phase;
generating, using the IFFT-processed signals, the sub-band signals used for generating the single broadband signal; and
sequentially combining, using an N:1 multiplexer, the sub-band signals used for generating the single broadband signal.

19. The method of claim 18, wherein the generating comprises transforming, using N polyphase filters, the IFFT-processed signals into the sub-band signals used for generating the single broadband signal.

20. The method of claim 18, wherein the generating comprises:
dividing, by N 1:k demultiplexer, each of the IFFT-processed signals into k signals; and
generating the sub-band signals used for generating the single broadband signal, using k*N polyphase filters, groups of k polyphase filters being respectively connected with one of the N 1:k demultiplexers.
